(19) United States
(12) Patent Application Publication
(10) Pub. No.: US 2005/0075456 A1
(43) Pub. Date: Apr. 7, 2005

(54) Novel synthetic route for the preparation of hydroxy terminated polyarylates

(76) Inventors: Daniel Joseph Brunelle, Burnt Hills, NY (US); Joseph Anthony Suriano, Clifton Park, NY (US); Corrado Berti, Ravenna (IT); Annamaria Celli, Forli (IT); Martino Colonna, Bologna (IT); Maurizio Fiorini, Bologna (IT); Elisabetta Marianucci, Bologna (IT); Paola Marchese, Bologna (IT); Massimo Messori, Modena (IT); Laura Sisti, Bologna (IT)

Correspondence Address: Raymond E. Farrell, Esq.;Carter, DeLuca, Farrell & Schmidt, LLP, Suite 225, 445 Broad Hollow Road, Melville, NY, 11747, US

(21) Appl. No.: 10/676,199

(22) Filed: Oct. 1, 2003

(51) Int. Cl. C08L 1/00

(52) U.S. Cl. 525/152; 525/394; 525/425; 525/439

(57) ABSTRACT

Efficient and cost-effective methods for producing hydroxyl-terminated arylates are disclosed. These arylates are useful in forming block polyarylate-polycarbonate copolymers.

### BACKGROUND OF INVENTION

1. Technical Field

This disclosure relates to a new synthetic route for the preparation of polyarylates to be used in the synthesis of thermally stable and weatherable polymers.

2. Background of Related Art

Various polymeric articles have a problem of long-term color instability. In many cases this instability is seen as yellowing of the polymer, detracting from its attractiveness and also its transparency when the polymer was initially transparent. Loss of gloss can also be an undesirable long-term phenomenon. Another problem is the susceptibility to attack by organic liquids.

One way of protecting a resinous article against photoyellowing and loss of gloss is to utilize a multilayer approach, in which the top layer of the article is a weatherable polymer attached to a structural substrate. The term “weatherable” as used herein signifies resistance to such phenomena as ultraviolet light, heat, and moisture. Coatings made from polyesters containing resorcinol arylate units often possess good weatherability properties. The arylate moieties typically contain isophthalate, terephthalate, and especially mixtures of iso- and terephthalate units. Polyesters of resorcinol with mixtures of isophthalate and terephthalate chain members typically have good weatherability properties and may provide protection against photoyellowing when coated over a substrate.

Methods for the synthesis of polyesters containing resorcinol arylate chains by interfacial methods, and articles produced thereby, are described in U.S. Pat. Nos. 6,306,507, 6,294,647, 6,291,589 and 6,265,522. In the interfacial methods, about a 1:1 stoichiometric ratio of resorcinol to either iso- or terephthaloyl dichloride, or a mixture thereof, are introduced in water and a water-immiscible solvent such as chloroform or dichloromethane in the presence of aqueous sodium hydroxide. The method provides a polymer with weight average molecular weight (Mw) of about 15,000-25,000.

This partially-capped, hydroxy-terminated polyarylate, which is an isophthalate/terephthalate/resorcinol (ITR) arylate, can then be further reacted with bisphenol A and phosgene to form a block polyarylate-polycarbonate copolymer (PC-ITR-PC) as depicted in FIG. 1. This method requires the use of acyl chlorides that are expensive monomers and the use of large volume of a chlorinated solvent.

Two different polymerization routes are reported in the literature for the melt synthesis of polyarylates: the diacetate route and the diphenyl ester route. See Dean, et al., “Polyarylates” in Comprehensive Polymer Science, Pergamon Press, Vol. 5, Chapter 18, page 317.

The diacetate route involves the reaction of stoichiometric amounts of an aromatic dicarboxylic acid with the diacetate derivative of an aromatic diphenol at high temperatures. It is generally observed in the diacetate process that sublimation of diacid occurs when a diester of dihydric phenol is reacted with an aromatic dicarboxylic acid in the molten state. This upsets the stoichiometry of the reactants and results in products having insufficient molecular weight. To overcome this problem a variety of solvents have been suggested to reduce sublimation of the reactants. The preferred organic solvents are a diphenylether compound as described in U.S. Pat. No. 4,294,956; a cycloaliphatic substituted aromatic or heteroaromatic compound as described in U.S. Pat. No. 4,294,957; and a halogenated and/or etherated substituted aromatic or heteroaromatic compound as described in U.S. Pat. No. 4,374,239.

Yet another problem associated with production of aromatic polyesters by the diacetate process is the formation of carboxylic acid as a by-product of the reaction of phenol diacetate with an aromatic dicarboxylic acid.

The diphenyl ester route for the production of polyarylates consists of the reaction at high temperature of a diaryl ester of an aromatic dicarboxylic acid with an aromatic diphenol. The reaction produces high molecular weight aromatic polyester(s) and is preferred over the diacetate route on the basis of final product properties and cost.

The diaryl ester of an aromatic dicarboxylic acid can be synthesized by reaction of diphenyl carbonate and aromatic acids in the presence of acid or basic catalysts. Some methods have disclosed a simplification of the diphenate process by the base catalyzed in situ generation of the diaryl ester of the aromatic diacid with a diaryl carbonate in the presence of the aromatic diphenol. See U.S. Pat. No. 3,553,167. However, this process is very long (more than 8 hours) and the final products are brightly colored. Another difficulty with this process is that the starting diacids (iso- and terephthalic acid) are high melting solids insoluble in most solvents; their incorporation into a polymer depends upon reaching a clearing point during polymerization in which all the acid dissolves into the molten polymer or oligomer.

It would be desirable to develop improved economical and efficient methods for producing arylate oligomers that do not require the use of acyl chlorides and chlorinated solvents yet still result in the formation of hydroxy-terminated polymers.

### SUMMARY OF INVENTION

The present disclosure provides an improved process for the preparation of hydroxy-terminated arylate oligomers comprising heating a mixture of at least one aromatic diol, at least one dicarboxylic acid, and at least one diaryl carbonate in the presence of a metal catalyst.

In one embodiment, the method of the present disclosure involves:
a) combining at least one aromatic diol, at least one dicarboxylic acid, and at least one diaryl carbonate to provide a mixture;
b) heating the mixture in the presence of a catalyst selected from the group consisting of metal alkoxides, metal oxides and metal carboxylates; and
c) applying a vacuum to prepare a hydroxy-terminated arylate oligomer.

In another embodiment, the mixture is cooled before the step of applying the vacuum to prepare the hydroxy-terminated arylate oligomer.

In one embodiment, the polyarylate is a hydroxy-terminated isophthalate/terephthalate/resorcinol (ITR) arylate prepared by combining 1,3-dihydroxybenzene, a first mixture of isophthalic acid and terephthalic acid, and diphenyl carbonate to provide a second mixture and heating the second mixture in the presence of a titanium tetrabutoxide catalyst and a sodium dihydrogen phosphate co-catalyst.

### BRIEF DESCRIPTION OF DRAWINGS

FIG. 1 is a depiction of the synthesis route for block polyarylate-polycarbonate copolymers.

FIG. 2 is a depiction of the synthesis route in accordance with the present disclosure for the production of hydroxy-terminated arylate oligomers.

### DETAILED DESCRIPTION

In accordance with the present disclosure, methods are provided for the synthesis of hydroxy terminated oligomers by one pot reaction of at least one aromatic diol, at least one dicarboxylic acid, and at least one diaryl carbonate in the presence of a metal alkoxide catalyst.

Suitable aromatic diols which may be utilized in accordance with the methods of the present disclosure include, for example, 2,2-bis(4-hydroxyphenyl)propane (bisphenol A), 1,1-bis(4-hydroxyphenyl) cyclohexane (bisphenol Z), 1,1-bis(4-hydroxyphenyl)ethane, bis(4-hydroxyphenyl)methane, 1,2-bis(4-hydroxyphenyl)ethane, bis(4-hydroxyphenyl)phenylethane, bis(4-hydroxyphenyl)cyclohexylmethane, 3,3-bis(4-hydroxyphenyl) pentane, bis(4-hydroxyphenyl)sulfone, bis(4-hydroxyphenyl)ether and 4,4′biphenol. These compounds may be used either singly or in combinations of two or more thereof.

In one embodiment the aromatic diol is 1,3-dihydroxybenzene, commonly referred to as resorcinol. Resorcinol as used within the context of the present disclosure should be understood to include both unsubstituted 1,3-dihydroxybenzene and substituted 1,3-dihydroxybenzenes unless explicitly stated otherwise. Suitable resorcinol moieties comprise units of Formula I: 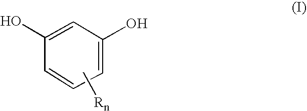
wherein R is at least one of C₁₋₁₂ alkyl or halogen, and n is 0-3. Alkyl groups, if present, are preferably straight-chain or branched alkyl groups, and are most often located in the ortho position to both oxygen atoms although other ring locations are contemplated. Suitable C₁₋₁₂ alkyl groups include methyl, ethyl, n-propyl, isopropyl, butyl, iso-butyl, t-butyl, nonyl, decyl, and aryl-substituted alkyl, including benzyl, with methyl being particularly preferred. Suitable halogen groups are bromo, chloro, and fluoro. The value for n may be 0-3, preferably 0-2, and more preferably 0-1. A preferred resorcinol moiety is 2-methylresorcinol. The most preferred resorcinol moiety is an unsubstituted resorcinol moiety in which n is zero. As noted above, resorcinol can be mixed with other aromatic diols.

Suitable dicarboxylic acids for use in accordance with the present disclosure include isophthalic acid, terephthalic acid, mixtures of isophthalic and terephthalic acids, diphenyl dicarboxylic acids, diphenylether dicarboxylic acids, naphthalenedicarboxylic acids, especially naphthalene-2,6-dicarboxylic acid, and mixtures thereof.

The third component of the reaction mixture in accordance with the present disclosure is a diaryl carbonate. Suitable diaryl carbonates include diphenyl carbonate, ditolyl carbonate, bis-(2-chlorophenyl) carbonate, bis-(2-nitrophenyl) carbonate, bis-(2-carbonylmethoxy) carbonate, dinaphthyl carbonate, bis(diphenyl) carbonate, and mixtures thereof.

The molar ratio of aromatic diol to dicarboxylic acid to diaryl carbonate can range from about 1.1:1.0:2.0 to about 2.0:1.0:2.50, preferably from about 1.2:1.0:2.02 to about 1.5:1.0:2.25, with a ratio of about 1.3:1.0:2.05 being most preferred.

While basic catalysts have previously been used for the production of polyarylates, in accordance with the present disclosure Lewis acid catalysts, preferably metal alkoxide-type catalysts, are utilized in a melt process. These catalysts are consistently more active in transesterification reactions compared to basic catalysts.

The catalyst employed may include alkoxides of Group IVB metals and derivatives of Group IVA metals, metal oxides, and metal carboxylates. Suitable catalysts include titanium butoxide, titanium tetrabutoxide, titanium propoxide, titanium phenoxide, antimony trioxide, zirconium butoxide, dialkyltin dialkoxides, dibutyltin oxide, dibutyltin diesters, tin phenoxide, etc. The use of a titanium compound such as titanium tetrabutoxide, an antimony compound such as antimony trioxide or an organo tin compound such as dibutyltin oxide as catalyst is especially to be preferred, since the effects on reaction time are great and quenched polymers having a satisfactory color tone can be obtained.

The amount of catalyst employed may be quite low and can range from about 10 ppm to about 1000 ppm (metal with respect to the final polymer), preferably from about 20 ppm to about 500 ppm, with a range from about 25 ppm to about 100 ppm being most preferred.

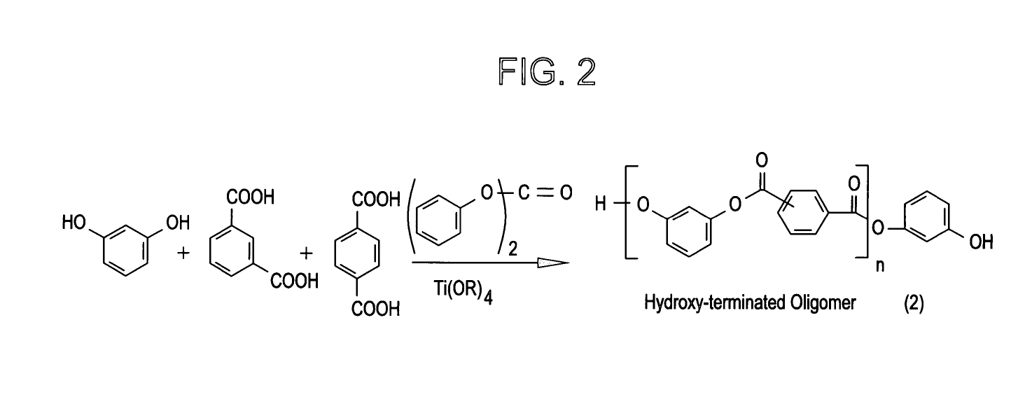

The general reaction scheme for producing these hydroxyl-terminated arylates is set forth in FIG. 2 using a titanium catalyst. In general, the aromatic diol, dicarboxylic acid and diaryl carbonate are added to a reactor in combination with the catalyst to produce the desired hydroxy-terminated arylate oligomer.

As the metal alkoxide catalysts may impart an orange or yellow color to the resulting polymer, a co-catalyst selected from the group of alkali metal phosphate, alkali metal phosphite, alkali metal hypophosphite or alkali metal polyphosphate may be included to increase the rate of the reaction.

The alkali metal phosphate can be a phosphate salt containing one, two, or three alkali metal groups; the alkali metal phosphite can be a phosphite salt containing one or two alkali metal groups; the alkali metal hypophosphite can be a hypophosphite salt containing any number of alkali metal groups; and the alkali metal polyphosphate can be a polyphosphate salt containing one, two, three, four, or five alkali metal groups. The co-catalyst not only increases the reaction rate in the production of the desired polyarylate, it also improves the color of the resulting product. Preferably, the co-catalyst is an alkali metal phosphate, with sodium dihydrogen phosphate being most preferred.

The amounts of the co-catalyst may vary, with the molar ratio of co-catalyst to catalyst ranging from about 2:1 to about 10:1, preferably from about 3:1 to about 6:1, most preferably at a ratio of about 4:1. Attenuation of the undesired color indicates a reduction in the amount of undesired side reaction product.

In addition, where a titanium catalyst is used any discoloration of the final product due to the formation of aromatic titanates can be minimized using a catalyst quencher (e.g., phosphoric acid, phosphorous acid, organic phosphites, etc.).

The polymerization reaction proceeds in two stages. In the first stage of the reaction, the starting materials are added to the reactor, heated, and the reaction is allowed to proceed until the pre-polymer clarifies (sometimes referred to herein as clearing). During the second stage of the reaction (after clearing), the temperature of the reactor is either maintained or reduced and a vacuum is then slowly applied to remove by-products, which are primarily phenols.

The temperature of the first stage of the reaction may range from about 230° to about 300° C. or higher, with a temperature of from about 260° to about 290° C. being preferred. The temperature of the second stage of the reaction can range from about 190° to about 300° C., preferably from about 190° to about 290° C., with a temperature of from about 210° to about 260° C. being most preferred.

Reaction times for the first stage may vary from about 25 minutes to about 400 minutes, preferably from about 100 to about 200 minutes. Reaction times for the second stage may vary from about 60 minutes to about 240 minutes, preferably from about 100 to about 200 minutes. As can be appreciated by one skilled in the art, the reaction time will vary depending upon such factors as the form of the polymer, temperature, etc.

The first stage of the polymerization reaction is generally conducted at atmospheric pressure. The second stage of the reaction is conducted at a pressure ranging from about 60 mbar to 0.01 mbar, with a range of from about 1 mbar to about 0.02 mbar being preferred. In some embodiments, it is preferred to conduct the polymerization under a stream of an inert gas, such as nitrogen or argon.

In some embodiments, the polymer is subjected to a purge with an inert gas such as nitrogen or argon in an amount ranging from about 0.1 l/min to about 10.0 l/min during the polymerization reaction, preferably about 0.5 l/min, in order to reduce any discoloration as a result of thermal oxidation during the polymerization process.

In accordance with the present disclosure, additives such as stabilizers, colorants, etc., that are commonly used in the preparation of polyesters may be included.

The arylate produced by this reaction has a Mw ranging from about 1000 to about 50,000 and in some embodiments preferably ranges from about 2000 to about 20,000.

In another embodiment, the aromatic diol utilized is resorcinol due to the high thermal and UV resistance of its polyarylates; the dicarboxylic acid is a mixture of isophthalic and terephthalic acids; and the diaryl carbonate is diphenyl carbonate. The resulting ITR arylate preferably has a Mw of less than about 10,000, more preferably from about 1,000 to about 10,000.

Various combinations of starting materials may be utilized in accordance with the present disclosure to produce hydroxy terminated polyarylates. For example, hydroxy terminated polyarylates can be prepared from phthalic acids, bisphenol A and diphenyl carbonate, and from 2,6-naphthalene dicarboxylic acid, resorcinol and diphenyl carbonate. The Mw of the arylate can be adjusted depending upon the starting materials and reaction conditions. As noted above, in one embodiment a hydroxy-terminated ITR arylate is made which can have a Mw ranging from about 1,000 to about 50,000, more preferably from about 1,000 to about 10,000. It has been found that to obtain lower Mw arylate oligomers, the time of the second stage of the polymerization reaction should preferably range from about 100 minutes to about 195 minutes, more preferably about 150 to about 190 minutes.

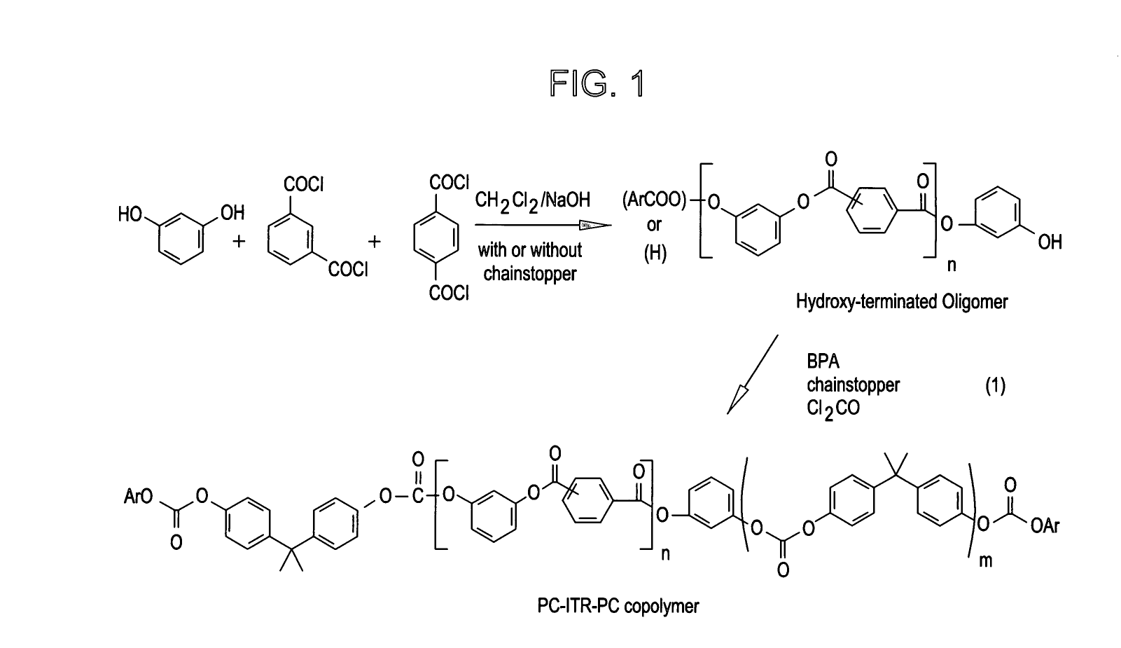

Because the resulting oligomers have a high degree of hydroxy functionalization, i.e., a greater degree of hydroxy-termination, they may be utilized to form block PC-ITR-PC copolymers as depicted in FIG. 1, without the need for expensive acyl chloride monomers or large amounts of chlorinated solvents that are required in the interfacial methods of production.

In other embodiments, the present disclosure can successfully utilize other aromatic diols (e.g. bisphenol A,) and other dicarboxylic acids (e.g. 2,6-naphthalene dicarboxylic acid) in the synthesis of polyarylates having molecular weights approaching 50,000. In such a case the reaction time of the second stage of the polymerization ranges from about 180 minutes to about 240 minutes, more preferably from about 200 minutes to about 230 minutes. For example, polymers with Mw of approximately 50,000 can be obtained by increasing the reaction time of the second stage of the polymerization reaction at 0.1 mbar to about 3 hours. In fact, depending on the reaction conditions, high molecular weight polymers may be made having molecular weights ranging from about 30,000 to about 60,000.

The present invention will now be described more specifically with reference to the following examples. It is to be noted that the following examples are presented herein for purpose of illustration and description; they are not intended to be exhaustive or to limit the invention to the precise form disclosed.

### EXAMPLE 1

A series of reactions were performed in order to determine the most appropriate catalyst for the arylate polymerization reaction. A glass tube (15 cm length, 1.5 cm internal diameter) provided with a stopcock, was charged with 0.415 g of terephthalic acid (TPA), 0.415 g of isophthalic acid (IPA), 0.578 g of resorcinol (RES) and 2.182 g of diphenyl carbonate (DPC) (giving a molar ratio of phthalic acids/resorcinol/diphenyl carbonate of 1/1.05/2.05). The catalyst (0.5% by mol respect to phthalic acids; 800 ppm) dissolved in anhydrous toluene was then added. The glass vial was then purged with argon and immersed in a silicon oil bath at a temperature of 260° C. The equilibrium of the reaction was shifted towards the formation of the polyarylate by the continuous distillation of the phenol formed. To analyze the catalytic activity, the time needed to obtain a transparent reaction melt (clearing time) was used to indicate when no unreacted phthalic acid was left.

After the reaction melt was transparent the temperature was reduced to 210° C. and dynamic vacuum (60 mbar) was applied. The reaction was then kept at this temperature for 30 minutes, for 30 minutes at 230° C. and for 30 minutes at 260° C. The internal pressure was then reduced to 0.1 mbar and the reaction was stopped after 30 minutes at this pressure.

The final oligomers were analyzed by ¹H-NMR and Fourier-transform infrared (FTIR) spectroscopy and Mw of the arylate was obtained by gel permeation chromatography (GPC). ¹H-NMR analysis was performed on a Varian Gemini System 300 MHz instrument following the manufacturer's instructions using CDCl₃ as solvent and tetramethylsilane (TMS) as reference. GPC analysis was performed by using chloroform as eluent (elution rate of 0.8 ml·min⁻¹) on a HP 1100 Series apparatus equipped with a PL gel 5 μm Mixed-C column and a UV detector. Calibration was performed using polystyrene standards. FTIR analysis was performed on a Perkin Elmer SpectrumOne spectrometer equipped with an Universal ATR sampling accessory. The results are summarized below in Table 1.

TABLE 1
Small scale catalyst screening

| | Catalyst molar ratio | Clearing | |
|---|---|---|---|
| Catalyst tested | respect to phthalic acid | time | Mw |
| Ti(OBu)₄ | 0.5% | 25 min | 6500 |
| Zr(OBu)₄ | 0.5% | 75 min | 5600 |
| Bu₂Sn(OMe)₂ | 0.5% | 110 min | 6500 |
| BuSnO(OH) | 0.5% | 180 min | 4500 |
| KOH | 0.5% | 195 min | 3200 |
| Sb₂O₃ | 0.5% | 210 min | 3800 |
| no cat | — | 400 min | 3100 |

The spectroscopic results demonstrated the absence of side reactions and the complete disappearance of carbonate groups and of carboxylic acid groups with the consequent formation of aromatic ester moieties. The end groups were mainly phenyl ester. The distillate was composed of phenol (96% by mol), unreacted DPC (2% by mol) and unreacted resorcinol (2% by mol).

Titanium tetrabutoxide (TBT) proved to be the most efficient catalyst for this reaction and for this reason it was used in later experiments. As low levels of titanium were required, the mol % of titanium was converted to ppm as follows: 0.25% Ti by mol with respect to phthalics is equivalent to 400 ppm Ti with respect to the final polymer; 0.031% Ti by mol with respect to phthalics is equivalent to 50 ppm Ti with respect to the final polymer.

### EXAMPLE 2

This example focused on the temperature profile and resorcinol/phthalic acids molar ratio of the reaction to optimize the process to obtain fully hydroxy-terminated oligomers. The molar ration of resorcinol/phthalic acids varied from 1.05 to 1.30.

A typical polymerization was carried out as follows. A round bottom wide-neck glass reactor (250 mL volume) was charged with 8.307 g of terephthalic acid, 8.307 g of isophthalic acid, 14.317 g of resorcinol, 43.480 g of diphenyl carbonate and 85 mg (400 ppm) of titanium tetrabutoxide corresponding to a TPA/IPA/RES/DPC=0.50/0.50/1.30/2.03 molar ratio. The reactor was closed with a three-neck flat flange lid equipped with a mechanical stirrer and a torque meter. The lid was heated at a temperature of 120-140° C. with a heating band. The system was then connected to a liquid nitrogen cooled condenser and immersed in an oil-bath at the temperature of 260° C. (temperature of the oil bath) (initial time, to).

The first stage of the polymerization was carried out at 260° C., at atmospheric pressure and without stirring for 120 minutes. The phenol formed during the reaction was distilled off the reactor and recovered in the condenser. CO₂ evolution started after ca. 15 minutes; the system reached the clearing point after 45 minutes from the beginning of the reaction. Stirring was set on (50 rpm) after 120 minutes.

After clearing, the second stage of the polymerization proceeded by exposing the samples to various temperatures ranging from 260° C. to 210° C. for periods of time ranging from 30 to 180 minutes. Total time of exposure ranged from 180 to 300 minutes. Pressure was also adjusted at various times after clearing by slowly and carefully applying vacuum and decreasing the internal pressure from atmospheric to 60 mbar in approximately 10 minutes. For each sample, the final internal pressure was decreased to 0.1 mbar and the reaction was stopped after either 30 minutes or 90 minutes at this pressure.

Final discoloration was reduced using an argon purge during the reaction (0.5 I/min) and a catalyst quencher (phosphorous acid) was added at the end of the polymerization process by stirring the reaction melt for 20 minutes. The amount of catalyst quencher was 10 times the weight of the TBT.

The oligomers produced were analyzed by ¹H-NMR spectroscopy as in Example 1 and Mn was calculated. An ITR arylate produced by interfacial methods was used for comparison. The variations in temperature, pressure and resorcinol/phthalic acids molar ratio for the samples and the results of these analyses are set forth below in Table 2.

TABLE 2
Glass reactor process optimization (temperature profile and resorcinol/
phthalics molar ratio)

| | Time-Temperature profile | | | | | | |
|---|---|---|---|---|---|---|---|
| Resorcinol/ | 260° C. | 210° C. | 230° C. | 260° C. | 260° C. | OH/phthalics | |
| Phthalics | after clear | 60 mbar | 60 mbar | 60 mbar | 0.1 mbar | (¹H-NMR) | Mn |
| 1.05 | 0 | 30 min | 30 min | 30 min | 90 min | 0.0178 | 3500 |
| 1.10 | 0 | 30 min | 30 min | 30 min | 90 min | 0.0243 | 3400 |
| 1.15 | 0 | 30 min | 30 min | 90 min | 90 min | 0.0362 | 4100 |
| 1.15 | 60 min | 30 min | 30 min | 90 min | 90 min | 0.0227 | 6900 |
| 1.15 | 180 min | 0 | 0 | 30 min | 30 min | 0.0489 | 4600 |
| 1.30 | 180 min | 0 | 0 | 30 min | 30 min | 0.0607 | 4500 |
| Interfacial ITR | | | | | | 0.0193 | 13800 |

In this case it was found that the OH/phthalic molar ratio (measured by ¹H-NMR as in Example 1), when correlated with the number average molecular weight (Mn), was an indication of hydroxy end group functionalization. As can be seen from Table 2, the best results were obtained using a 1.30 resorcinol/phthalic acids molar ratio without decreasing the temperature to 210° C. Indeed, comparing the product obtained by this experiment with the oligomers obtained by the interfacial method (Interfacial ITR) showed a 3.2 fold increase of hydroxy end groups with a 3.1 Mn decrease. This indicates that the oligomers obtained using a 30% excess of resorcinol had a very similar hydroxy end group percentage compared to the ones obtained via the interfacial route (that are 95% hydroxy terminated).

### EXAMPLE 3

The time needed to obtain a transparent reaction melt (clearing time) for various concentrations of TBT was determined. A polymerization reaction was first allowed to proceed as described above in Example 2. As it is well known that aromatic titanates give rise to orange discoloration, sodium dihydrogen phosphate, a transesterification cocatalyst for titanium, was added in some instances at a molar ratio of 4:1 with respect to the amount of Ti to reduce the catalyst level. A basic catalyst, KOH, was used as a control. The results, including spectroscopic results obtained as per the procedures in Example 1, are set forth below in Table 3.

TABLE 3
Glass reactor process optimization (catalyst level)

| Cata- | Catalyst | | Cocatalyst | Clearing | |
|---|---|---|---|---|---|
| lyst | concentration | Cocatalyst | concentration | time | Mw |
| TBT | 400 ppm | — | — | 45 min | 6900 |
| TBT | 400 ppm | NaH₂PO₄ | 4/1 respect to Ti | 25 min | 7800 |
| TBT | 100 ppm | NaH₂PO₄ | 4/1 respect to Ti | 75 min | 4300 |
| TBT | 50 ppm | NaH₂PO₄ | 4/1 respect to Ti | 110 min | 5100 |
| TBT | 25 ppm | NaH₂PO₄ | 4/1 respect to Ti | 220 min | 3100 |
| KOH | 400 ppm | — | — | 350 min | 2700 |
| No | — | — | — | 500 min | 1900 |
| cat | | | | | |

As can be seen from Table 3, the optimum balance of reaction rate and discoloration was obtained using a TBT level of 50 ppm (as titanium with respect to the final polymer) using NaH₂PO₄ as cocatalyst. The results in Table 3 demonstrate that the use of a basic catalyst (as disclosed in U.S. Pat. No. 3,553,167) is not suitable for the synthesis of polyarylates due to the very long reaction times required.

### EXAMPLE 4

The effect of higher temperatures on the process was then analyzed. Samples prepared by the polymerization reaction as described above in Example 2 were subjected to temperatures ranging from 260° C. to 290° C. with the amount of catalyst and cocatalyst remaining the same as in Example 3 (i.e., the molar ratio of co-catalyst to catalyst was 4:1). Clearing time was determined as described in Example 1 above. The results are set forth in Table 4 below.

TABLE 4
Glass reactor process optimization (reaction temperature)

| | | Catalyst | | Clearing |
|---|---|---|---|---|
| Catalyst | Temperature | concentration | Cocatalyst | time |
| TBT | 260° C. | 50 ppm | NaH₂PO₄ | 110 min |
| TBT | 280° C. | 50 ppm | NaH₂PO₄ | 50 min |
| TBT | 290° C. | 50 ppm | NaH₂PO₄ | 40 min |
| no cat | 260° C. | — | — | 500 min |
| no cat | 290° C. | — | — | 115 min |

The resulting oligomers were subjected to spectroscopic analysis as described above in Example 1. The results showed that no side reaction occurred even when the reaction temperature was 290° C. The color of the final product did not differ from that of the oligomers obtained at 260° C. At 290° C., a consistent reduction of the clearing time was also observed in the absence of the catalyst.

### EXAMPLE 5

A round bottom wide-neck glass reactor (250 mL volume) was charged with 8.307 g of terephthalic acid, 8.307 g of isophthalic acid, 26.255 g of bisphenol A (BPA), 43.480 g of diphenyl carbonate (corresponding to a TPA/IPA/BPA/DPC=0.50/0.50/1.15/2.03 molar ratio, 10.6 mg of titanium tetrabutoxide and 15.0 mg of NaH₂PO₄. The reaction was conducted according with the procedure described in Example 2. The final oligomers had Mn of 4300 and a OH/phthalics ratio of 0.0461. No side products were detected by ¹H-NMR and FTIR analysis.

### EXAMPLE 6

A round bottom wide-neck glass reactor (250 mL volume) was charged with 8.307 g of terephthalic acid, 8.307 g of isophthalic acid, 10.012 g of resorcinol, 43.480 g of diphenyl carbonate (corresponding to a TPA/IPA/RES/DPC=0.50/0.50/1.1/2.03 molar ratio), 10.6 mg of titanium tetrabutoxide and 15.0 mg of NaH₂PO₄. The reactor was closed with a three-neck flat flange lid equipped with a mechanical stirrer and a torque meter. The lid was heated at a temperature of 120-140° C. with a heating band. The system was then connected to a liquid nitrogen cooled condenser and immersed in an oil-bath at the temperature of 260° C. (temperature of the oil bath) (initial time, to). An argon flow (0.5 l·min⁻¹) was used.

The first stage of the polymerization was carried out at 260° C., at atmospheric pressure and without stirring for 120 min. The phenol formed during the reaction was distilled off the reactor and recovered in the condenser. Stirring was set on (50 rpm) after 120 min.

For the second stage of the polymerization, vacuum was then slowly and carefully applied decreasing the internal pressure from atmospheric to 60 mbar in approximately 10 min. After 30 more minutes the internal pressure was decreased to 0.1 mbar. The reaction was kept at this temperature and pressure for 2 hours and for an additional hour at 290° C. and 0.1 mbar yielding a very viscous polyarylate with Mw=49200. No side products were detected by ¹H-NMR and FTIR analysis.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

1. A method comprising:
a) combining at least one aromatic diol, at least one dicarboxylic acid, and at least one diaryl carbonate to provide a mixture;
b) heating the mixture in the presence of a catalyst selected from the group consisting of metal alkoxides, metal oxides and metal carboxylates; and
c) applying a vacuum to prepare a hydroxy-terminated arylate oligomer.

2. The method of claim 1 wherein the heating step comprises heating the mixture to a temperature ranging from about 230° to about 300° C.

3. The method of claim 1 wherein the heating step comprises heating the mixture for a period of time ranging from about 25 minutes to about 400 minutes.

4. The method of claim 1 wherein the applying the vacuum step further comprises reducing the pressure to an amount ranging from about 60 mbar to about 0.01 mbar.

5. The method of claim 1 wherein the applying the vacuum step further comprises cooling the mixture to a temperature ranging from about 190° to about 290° C.

6. The method of claim 1 wherein the applying the vacuum step occurs for a period of time ranging from about 60 minutes to about 240 minutes.

7. The method of claim 1 wherein the combining step comprises combining the at least one aromatic diol, the at least one dicarboxylic acid and the at least one diaryl carbonate at a molar ratio of from about 1.1:1.0:2.0 to about 2.0:1.0:2.50.

8. The method of claim 1 wherein the combining step comprises combining at least one aromatic diol selected from the group consisting of 2,2-bis(4-hydroxyphenyl)propane, 1,1-bis(4-hydroxyphenyl) cyclohexane, 1,1-bis(4-hydroxyphenyl)ethane, bis(4-hydroxyphenyl)methane, 1,2-bis(4-hydroxyphenyl)ethane, bis(4-hydroxyphenyl)phenylethane, bis(4-hydroxyphenyl)cyclohexylmethane, 3,3-bis(4-hydroxyphenyl) pentane, bis(4-hydroxyphenyl)sulfone, bis(4-hydroxyphenyl)ether, 1,3-dihydroxybenzene, and mixtures thereof.

9. The method of claim 1 wherein the combining step comprises selecting 1,3-dihydroxybenzene as the at least one aromatic diol.

10. The method of claim 1 wherein the combining step comprises combining at least one dicarboxylic acid selected from the group consisting of isophthalic acid, terephthalic acid, diphenyl dicarboxylic acids, diphenylether dicarboxylic acids, naphthalenedicarboxylic acids, naphthalene-2,6-dicarboxylic acid, and mixtures thereof.

11. The method of claim 1 wherein the combining step comprises combining a mixture of isophthalic and terephthalic acids as the at least one dicarboxylic acid.

12. The method of claim 1 wherein the combining step comprises combining at least one diaryl carbonate selected from the group consisting of diphenyl carbonate, ditolyl carbonate, bis-(2-chlorophenyl) carbonate, bis-(2-nitrophenyl) carbonate, bis-(2-carbonylmethoxy) carbonate, dinaphthyl carbonate, bis(diphenyl) carbonate, and mixtures thereof.

13. The method of claim 1 wherein the heating step comprises heating in the presence of a catalyst selected from the group consisting of titanium butoxide, titanium tetrabutoxide, titanium propoxide, titanium phenoxide, antimony trioxide, zirconium butoxide, dialkyltin dialkoxides, dibutyltin oxide, dibutyltin diesters, and tin phenoxide.

14. The method of claim 1 wherein the heating step comprises heating in the presence of a metal alkoxide catalyst wherein the metal is selected from the group consisting of Group IVB metals or derivatives of Group IVA metals.

15. The method of claim 14 wherein the heating step comprises heating in the presence of a metal alkoxide catalyst in an amount ranging from about 10 ppm to about 1000 ppm with respect to the final polymer.

16. The method of claim 13 wherein the heating step further comprises adding a co-catalyst selected from the group consisting of phosphate salts containing one, two, or three alkali metal groups; phosphite salts containing one or two alkali metal groups; hypophosphite salts containing any number of alkali metal groups; and polyphosphate salts containing one, two, three, four, or five alkali metal groups.

17. The method of claim 16 wherein the heating step comprises heating in the presence of sodium dihydrogen phosphate as the co-catalyst.

18. The method of claim 16 wherein the heating step comprises adding the co-catalyst at a molar ratio of co-catalyst to catalyst ranging from about 2:1 to about 10:1.

19. The method of claim 1 further comprising subjecting the mixture to an argon purge of about 0.1 to about 10.0 l/min.

20. The method of claim 1 wherein the heating step produces a hydroxy-terminated arylate oligomer having a Mw ranging from about 1000 to about 50000.

21. The method of claim 1 wherein the combining step comprises combining 1,3-dihydroxybenzene as the at least one aromatic diol, a mixture of isophthalic acid and terephthalic acid as the at least one dicarboxylic acid, and diphenyl carbonate as the at least one diaryl carbonate.

22. The method of claim 21 wherein the applying the vacuum step occurs for a period of time ranging from about 100 minutes to about 195 minutes.

23. The method of claim 22 wherein the heating step produces a hydroxy-terminated arylate oligomer having a Mw ranging from about 2000 to about 20,000.

24. The method of claim 22 wherein the heating step produces a hydroxy-terminated arylate oligomer having a Mw of from about 1,000 to about 10,000.

25. A method comprising:
a) combining at least one aromatic diol, at least one dicarboxylic acid, and at least one diaryl carbonate to provide a mixture;
b) heating the mixture in the presence of a catalyst selected from the group consisting of metal alkoxides, metal oxides and metal carboxylates; and
c) applying a vacuum to prepare a polyarylate.

26. The method of claim 25 wherein the heating step comprises heating the mixture to a temperature ranging from about 230° to about 300° C.

27. The method of claim 25 wherein the heating step comprises heating the mixture for a period of time ranging from about 25 minutes to about 400 minutes.

28. The method of claim 25 wherein the applying the vacuum step further comprises reducing the pressure to an amount ranging from about 60 mbar to about 0.01 mbar.

29. The method of claim 25 wherein the applying the vacuum step further comprises cooling the mixture to a temperature ranging from about 190° to about 290° C.

30. The method of claim 25 wherein the applying the vacuum step occurs for a period of time ranging from about 200 minutes to about 230 minutes.

31. The method of claim 30 wherein the heating step produces a polyarylate having a Mw ranging from about 30,000 to about 60,000.

32. A method comprising:
a) combining 1,3-dihydroxybenzene, a first mixture of isophthalic acid and terephthalic acid, and diphenyl carbonate to provide a second mixture;
b) heating the second mixture in the presence of a titanium tetrabutoxide catalyst and a sodium dihydrogen phosphate co-catalyst; and
c) applying a vacuum to obtain a hydroxy-terminated isophthalate/terephthalate/resorcinol arylate oligomer.

33. The method of claim 32 wherein the heating step comprises heating the second mixture to a temperature ranging from about 260° to about 290° C.

34. The method of claim 32 wherein the heating step comprises heating the second mixture for a period of time ranging from about 100 minutes to about 200 minutes.

35. The method of claim 32 wherein the applying the vacuum step further comprises reducing the pressure to an amount ranging from about 1 to about 0.02 mbar.

36. The method of claim 35 wherein the applying the vacuum step further comprises cooling the second mixture to a temperature ranging from about 210° to about 260° C.

37. The method of claim 36 wherein the cooling step comprises cooling the second mixture for a period of time ranging from about 100 minutes to about 195 minutes.

38. The method of claim 32 wherein the combining step comprises combining the 1,3-dihydroxybenzene, the first mixture of isophthalic acid and terephthalic acid, and the diphenyl carbonate at a molar ratio of from about 1.2:1.0:2.02 to about 1.5:1.0:2.25.

39. The method of claim 32 wherein the heating step further comprises adding the titanium tetrabutoxide catalyst in an amount ranging from about 20 ppm to about 500 ppm with respect to the final polymer.

40. The method of claim 32 wherein the heating step further comprises adding the sodium dihydrogen phosphate co-catalyst at a molar ratio of co-catalyst to catalyst ranging from about 2:1 to about 10:1.

41. The method of claim 32 further comprising subjecting the mixture to an argon purge of about 0.1 to about 10.0 I/min.

42. The method of claim 32 wherein the heating step produces a hydroxy-terminated isophthalate/terephthalate/resorcinol arylate oligomer having a Mw ranging from about 2000 to about 20,000.

43. The method of claim 32 wherein the heating step produces a hydroxy-terminated isophthalate/terephthalate/resorcinol arylate oligomer having a Mw of from about 1,000 to about 10,000.
